(19) United States
(12) Patent Application Publication
(10) Pub. No.: US 2007/0060729 A1
(43) Pub. Date: Mar. 15, 2007

(54) Photosensitive resin composition and dry film resist using the same

(76) Inventors: Bong-Gi Kim, Gyeonggi-do (KR); Seong-Mo Park, Gyeonggi-do (KR); Chan-Seok Park, Gyeonggi-do (KR)

Correspondence Address: FISH & RICHARDSON PC, P.O. BOX 1022, MINNEAPOLIS, MN, 55440-1022, US

(21) Appl. No.: 10/555,706

(22) PCT Filed: May 6, 2004
(86) PCT No.: PCT/KR04/01049

§ 371 Date: Oct. 19, 2006

(30) Foreign Application Priority Data
May 7, 2003 (KR) 10-2003-0028970

(51) Int. Cl. C08F 30/02

(52) U.S. Cl. 526/274; 526/317.1; 526/319

(57) ABSTRACT

The present invention relates to an alkali-soluble photosensitive resin composition and a dry film resist using the same, more particularly to a photosensitive resin composition having superior heat resistance, chemical resistance and long-time stability and good adhesivity to a Cu or ITO (indium tin oxide) substrate by containing an acrylate resin, which is effective in improving adhesivity, and a photosensitive dry film resist using the same.

### TECHNICAL FIELD

The present invention relates to an alkali-soluble photosensitive resin composition and a dry film resist using the same, more particularly to a photosensitive resin composition used for etching of a Cu substrate or an ITO substrate, and a dry film resist using the same.

### BACKGROUND ART

With the recent high integration of electronic devices, demand on highly integrated circuits having narrow wiring and insulation patterns is on the increase. Also, demand on dry film resists having superior heat resistance, chemical resistance and long-time stability is on the increase.

The conventional dry film resists are limited in adhesivity to the substrate and resolution. To overcome these problems, adhesive enhancers such as silane coupler are used.

However, because the adhesive enhancers are unstable in itself, they tend to deteriorate storage stability of the composition.

### DISCLOSURE

### Technical Problem

It is an object of the present invention to provide an acrylate resin having good storage stability and improved adhesivity by copolymerizing an acrylate monomer containing phosphate ester with a polymer resin and a method of preparing the same.

It is another object of the present invention to provide a photosensitive resin composition having superior pattern formation ability, adhesivity, storage stability, heat resistance, chemical resistance and resolution using the acrylate copolymer resin.

It is still another object of the present invention to provide a dry film resist using the photosensitive resin composition.

### TECHNICAL SOLUTION

To attain the objects, the present invention provides an acrylate resin represented by the following Chemical Formula 1:

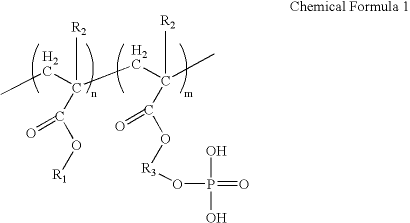

where R₁ is hydrogen or C₁ to C₆ alkyl having or not having an aromatic or hydroxy group; R₂ is hydrogen or methyl; R₃ is pentaethylene glycol, pentapropylene glycol or hexaethylene glycol; n is an integer of 8 to 40; and m is an integer of 1 to 4.

The present invention also provides a method of preparing the acrylate resin represented by Chemical Formula 1 comprising the step of copolymerizing a) 20 to 50 wt % of unsaturated carbonic acid, b) 15 to 45 wt % of aromatic monomer, c) 1 to 15 wt % of monomer containing phosphate ester and d) 10 to 30 wt % of acryl monomer in a solvent.

The present invention further provides an alkali-soluble photosensitive resin composition comprising the acrylate resin represented by Chemical Formula 1.

The photosensitive resin composition of the present invention preferably comprises a) 30 to 60 wt % of the acrylate resin represented by Chemical Formula 1; b) 5 to 30 wt % of cross-linking monomer having at least two ethylene double bonds; c) 0.5 to 10 wt % of photo-polymerization initiator; d) 0.5 to 3 wt % of dye and colorant; e) 0.2 to 1 wt % of additive; and f) solvent.

The present invention further provides a dry film resist obtained using the alkali-soluble photosensitive resin composition.

Hereinafter, the present invention is described in more detail.

The present invention is characterized by an acrylate resin containing phosphate ester, which is effective in adhesivity improvement, and a method of preparing the same.

The monomer used to prepare the acrylate resin of the present invention comprises a) unsaturated carbonic acid, b) aromatic monomer, c) monomer containing phosphate ester and d) acryl monomer.

The unsaturated carbonic acid is used to offer solubility in alkali. For the unsaturated carbonic acid, one or more compounds selected from the group consisting of acrylic acid, methacrylic acid, itaconic acid, maleic acid, fumaric acid, vinylacetic acid and acid anhydrides thereof may be used. Preferably, the unsaturated carbonic acid is comprised in 20 to 50 wt %. If the content of the unsaturated carbonic acid in the polymer exceeds 50 wt %, gelation tend to occur during polymerization, control of polymerization degree becomes difficult and storage stability of the photosensitive resin composition becomes poor. Otherwise, if the content of the unsaturated carbonic acid is below 20 wt %, developing time is extended.

The aromatic monomer is used to offer good adhesivity to the substrate and stable pattern formation during developing. For the aromatic monomer, styrene, benzyl methacrylate, benzyl acrylate, phenyl acrylate, phenyl methacrylate, 2- or 4-nitrophenyl acrylate, 2- or 4-nitrophenyl methacrylate, 2- or 4-nitrobenzyl methacrylate, 2- or 4-chlorophenyl acrylate or 2- or 4-chlorophenyl methacrylate may be used. Preferably, the aromatic monomer is comprised in 15 to 45 wt %, more preferably in 20 to 40 wt %. If the content of the aromatic monomer exceeds 45 wt %, developing time is extended, the composition becomes brittle and heat resistance increases, so that the photosensitive resin is not removed easily during the sintering process. Otherwise, if the content of the aromatic monomer is below 15 wt %, adhesivity to the glass plate reduces during the developing process, so that pattern peeling becomes intense and pattern linearity becomes aggravated, and thus it is difficult to obtain a stable pattern.

Particularly, the monomer containing phosphate ester, which is comprised in trace, improves adhesivity and controls acid value of the polymer. The monomer containing phosphate ester may vary according to the terminal functional groups of methacrylates containing double bonds. For example, pentaethylene glycol monomethacrylate, pentapropylene glycol monomethacrylate, hexaethylene glycol monomethacrylate and so forth may be used. Preferably, the monomer containing phosphate ester is comprised in 1 to 15 wt %, more preferably in 5 to 10 wt %. If the content of the monomer containing phosphate ester exceeds 15 wt %, gelation may occur during polymerization and pattern peeling becomes intense and pattern linearity becomes aggravated during developing because of poor alkali resistance. Otherwise, if the content of the monomer containing phosphate ester is below 1 wt %, adhesivity of the film is not improved.

The acryl monomer controls glass transition temperature and polarity of the polymer. For the acryl monomer, 2-hydroxyethyl (meth)acrylate, 2-hydroxyoctyl (meth)acrylate, methyl (meth)acrylate, ethyl (meth)acrylate or n-butyl acrylate may be used. Preferably, the monomer is comprised in 10 to 30 wt %, considering glass transition temperature, heat resistance and affinity to the developing solution of the polymer.

The acrylate copolymerization resin containing phosphate ester may be obtained from polymerization in a solvent having such a polarity as to prevent gelation of the four kinds of monomers. Preferable examples of such solvent are tetrahydrofuran, dioxane, dimethylaminoformaldehyde, methyl ethyl ketone, carbitol and γ-butyrolactone.

Polymerization may be performed according to general copolymerization methods. Preferably, the polymerization is performed at 40 to 80° C. for 4 to 10 hours, although not limited thereto.

The present invention is also characterized by a photosensitive resin composition for a dry film resist offering good adhesivity to the substrate, superior pattern formation ability even with small exposure amount, outstanding developing characteristics, superior storage stability and high resolution using the acrylate resin containing phosphate ester.

Preferably, the photosensitive resin composition for a dry film resist of the present invention comprises a) 30 to 60 wt % of the acrylate resin containing phosphate ester; b) 5 to 30 wt % of cross-linking monomer having at least two ethylene double bonds; c) 0.5 to 10 wt % of photo-polymerization initiator; d) 0.5 to 3 wt % of dye and colorant; e) 0.2 to 1 wt % of additive; and f) solvent.

The acrylate resin containing phosphate ester is represented by Chemical Formula 1 and preferably has a molecular weight ranging from 20,000 to 100,000, more preferably from 30,000 to 70,000. Preferably, the polymer has a glass transition temperature of at least 100° C. If the glass transition temperature is below 100° C., the composition may leak from the dry film (cold flow).

The photosensitive resin composition of the present invention preferably comprises 30 to 60 wt % of the acrylate resin represented by Chemical Formula 1 per 100 wt % of the composition. If the content of the acrylate resin is below 30 wt %, pattern formation becomes difficult. Otherwise, if it exceeds 60 wt %, softening point of the photosensitive resin composition rises, so that softness of the dry film may be poor.

Examples of the cross-linking monomer having at least two ethylene double bonds are 1,4-butanediol diacrylate, 1,3-butylene glycol diacrylate, ethylene glycol diacrylate, pentaerythritol tetraacrylate, triethylene glycol diacrylate, polyethylene glycol diacrylate, dipentaerythritol diacrylate, sorbitol triacrylate, bisphenol A diacrylate derivative, trimethylpropane triacrylate, dipentaerythritol polyacrylate and methacrylates thereof.

The cross-linking monomer having at least two ethylene double bonds is preferably comprised in 5 to 30 wt %, more preferably in 5 to 20 wt %, per 100 wt % of the photosensitive resin composition. If the content of the cross-linking monomer is below 5 wt %, pattern formation becomes difficult due to low degree of cure of the photosensitive resin. Otherwise, if it exceeds 30 wt %, pattern peeling becomes intense and pattern linearity becomes poor during developing due to high degree of cure.

For the photo-polymerization initiator, one or more compounds selected from the group consisting of triazine, benzoin, acetophenone, imidazole and xanthone may be used. Specific examples of the photo-polymerization initiator are 2,4-bistrichloromethyl-6-p-methoxystyryl-s-triazine, 2-p-methoxystyryl-4,6-bistrichloromethyl-s-triazine, 2,4-trichloromethyl-6-triazine, 2,4-trichloromethyl-4-methylnaphtyl-6-triazine, benzophenone, p-(diethylamino)benzophenone, 2,2-dichloro-4-phenoxyacetophenone, 2,2′-diethoxyacetophenone, 2,2′-dibutoxyacetophenone, 2-hydroxy-2-methylpropiophenone, p-t-butyltrichloroacetophenone, 2-methylthioxanthone, 2-isobutylthioxanthone, 2-dodecylthioxanthone, 2,4-dimethylthioxanthone, 2,4-diethylthioxanthone and 2,2′-bis-2-chlorophenyl-4,5,4′,5′-tetraphenyl-2′-1,2′-biimidazole.

The photo-polymerization initiator is preferably comprised in 0.5 to 10 wt %, more preferably in 2 to 5 wt %, per 100 wt % of the composition. If the content of the photo-polymerization initiator is below 0.5 wt %, normal pattern formation becomes difficult and pattern linearity becomes poor due to low sensitivity. Otherwise, if it exceeds 10 wt %, storage stability may become poor and pattern peeling may be intense during developing due to high degree of cure.

Examples of the dye and colorant are leuco crystal violet, tribromomethylphenylsulfone, diamond green GH, rhodamine B, auramine base, paramagenta, methyl orange, methylene blue, crystal violet, ethyl violet, phthalocyanine green, basic dye man chic blue 20 and night green B. These compounds may be used alone or in combination.

Preferably the dye and colorant is comprised in 0.5 to 3 wt % per 100 wt % of the composition. If the content of the dye and colorant is below 0.5 wt %, it is difficult to obtain vivid color by exposure. Otherwise, if it exceeds 3 wt %, exposure sensitivity may decrease.

The additive improves coating characteristics. For the additive, silicon or fluorine based surfactant may be used in 0.2 to 1 wt % per 100 wt % of the photosensitive resin composition. If the content of the additive is below 0.2 wt %, leveling characteristics of the composition is aggravated, so that it is difficult to obtain a uniform dry film. Otherwise, if it exceeds 1 wt %, pattern formation may be difficult.

The solvent is selected based on solubility and coating characteristics. Specific examples of the solvent are ethylene glycol monomethyl ether acetate, propylene glycol monomethyl ether, propylene glycol methyl ether acetate, propylene glycol monoethyl ether acetate, diethylene glycol dimethyl ether, diethylene glycol methyl ethyl ether, cyclohexanone, ethyl-3-methoxypropionate, methyl-3-ethoxypropionate, ethyl-3-ethoxypropionate, methyl ethyl ketone, isopropyl alcohol, ethanol and methanol. These solvents may be used alone or in combination. The content of the solvent is determined by other components. That is, it is determined to make the content of the total photosensitive resin composition 100 wt %.

To take a preferable example of preparing the dry film resist, the photosensitive resin composition is applied on a polyethylene terephthalate film (hereinafter referred to as PET film) to a uniform film thickness using an applicator and dried to form a photosensitive resin composition layer. Then, a polyethylene film (hereinafter referred to as PE film) is pressed on the dried photosensitive resin composition layer using a rubber roller, so that no foam remains, to obtain a photosensitive dry film resist.

### ADVANTAGEOUS EFFECTS

As described above, the present invention provides an acrylate resin having good storage stability and improved adhesivity by copolymerizing an acrylate monomer containing phosphate ester, which is effective in improving adhesivity, with a polymer resin.

Accordingly, the photosensitive resin composition of the present invention, which comprises an acrylate resin containing phosphate ester, has superior pattern formation ability, adhesivity, storage stability, heat resistance and chemical resistance and high resolution, so that it is suitable for etching a Cu substrate or an ITO substrate and preparing a dry film resist for an electronic device.

### BEST MODE

Hereinafter, the present invention is described in more detail through examples.

However, the following examples are only for the understanding of the present invention and they do not limit the present invention. Unless specified otherwise, percentage and mixing ratio in the examples are based on weight.

### EXAMPLES

### Preparing Examples 1 and 2 and Comparative Preparing Examples 1 and 2

(Preparation of Polymer Resin)

Acrylate copolymer resin represented by Chemical Formula 1 (Preparing Examples 1 and 2) and conventionally used acrylate copolymer resin (Comparative Preparing Examples 1 and 2) were prepared according to the composition and content shown in Table 1 below. 70 wt % of tetrahydrofuran (THF) was used as polymerization solvent. Polymerization was performed at 45° C. using a low-temperature initiator.

TABLE 1

| | | | Comparative | Comparative |
|---|---|---|---|---|
| | Preparing | Preparing | Preparing | Preparing |
| Classification | Example 1 | Example 2 | Example 1 | Example 2 |
| BM | 22 | 22 | 20 | 25 |
| MA | 25 | 25 | 30 | 30 |
| PAM-100 | 7 | — | — | — |
| PAM-200 | — | 7 | — | — |
| HEMA | 20 | 20 | 20 | 20 |
| MMA | 26 | 26 | 30 | 25 |
| Molecular | 30,000 | 28,000 | 30,000 | 29,000 |
| weight | | | | |

In Table 1, BM stands for benzyl methacrylate; MA stands for methacrylic acid; PAM-100 and PAM-200 are methacrylates containing phosphate ester produced by RHODIA; HEMA stands for 2-hydroxyethyl methacrylate; and MMA stands for methyl methacrylate.

### Examples 1 to 5 and Comparative Examples 1 to 3

(Preparation of Photosensitive Resin Composition)

Cross-linking monomer, photo-polymerization initiator, dye and colorant were added to the acrylate copolymer resin with the composition and content shown in Table 2 below. After the components were dissolved, the mixture was stirred at room temperature for 2 hours to obtain photosensitive resin compositions. The resultant photosensitive resin compositions were filtered with a 500-mesh filter to remove impurities.

TABLE 2

| | | Examples | | | | | Comp. Examples | | |
|---|---|---|---|---|---|---|---|---|---|
| Classification (wt %) | | 1 | 2 | 3 | 4 | 5 | 1 | 2 | 3 |
| Resin | Prep. Example 1 | 30 | — | 32 | — | 15 | — | — | — |
| | Prep. Example 2 | — | 30 | — | 32 | 15 | — | — | — |
| | Comp. Prep. Example 1 | — | — | — | — | — | 30 | — | 15 |
| | Comp. Prep. Example 2 | — | — | — | — | — | — | 30 | 15 |

| | | | | | | | | |
|---|---|---|---|---|---|---|---|---|
| MP(EO)₃TA | 14 | 14 | 10 | 10 | 14 | 14 | 14 | 14 |
| Irgacure 907 | 2 | 2 | 4 | 4 | 2 | 2 | 2 | 2 |
| A-DMA | 0.9 | 0.9 | 0.9 | 0.9 | 0.9 | 0.9 | 0.9 | 0.9 |
| Basic dye | 0.1 | 0.1 | 0.1 | 0.1 | 0.1 | 0.1 | 0.1 | 0.1 |
| PGMEA | 53 | 53 | 53 | 53 | 53 | 53 | 53 | 53 |

Note)
TMP(EO)₃TA: Trimethylopropane triacrylate, modified with ethylene oxide (produced by Japan Chemical)
Irgacure 907: Produced by Ciba Specialty Chemical
A-DMA: Produced by Hodogaya Chemical
PGMEA: Propylene glycol monomethyl ether acetate

Testing Example

A dry film resist was prepared using each photosensitive composition of Examples 1 to 5 and Comparative Examples 1 to 3. Adhesivity to the substrate, resolution, acid resistance and peeling characteristics were evaluated using the 30 μm-thick dry film resist.

1) Preparation of Dry Film Resist

Each photosensitive resin composition prepared in Examples 1 to 5 and Comparative Examples 1 to 3 was dried and applied on a 25 μm-thick PET film to a film thickness of 30 μm using an applicator. Then, it was dried to form a photosensitive resin composition layer. A 0 μm-thick PE film was pressed on the dried photosensitive resin composition layer using a rubber roller, so that no foams remained, to obtain a photosensitive dry film resist.

2) Evaluation of Adhesivity

After peeling the PE film off the obtained dry film resist, the photosensitive composition layer was pressed on the substrate using a hot roll of 80° C. After exposure all over the surface at 70 mJ/m², the PET film was peeled off and cross-cut test was performed according to STM D3359. The adhesivity evaluation result is given in Table 3 below.

[Evaluation Standard]

0B: Broken into pieces and over 65% is detached.

1B: 35% to 65% of edge and lattice at the cut part is detached.

2B: 15% to 35% of edge and lattice at the cut part is detached

3B: 5% to 15% of crossing at the cut part is detached.

4B: Less than 5% of crossing at the cut part is detached.

5B: Edge of the cut part is smooth and no lattice is detached.

TABLE 3
Evaluation of adhesivity

| Classification | Adhesivity |
|---|---|
| Example 1 | 5B |
| Example 2 | 5B |
| Example 3 | 5B |
| Example 4 | 5B |
| Example 5 | 5B |
| Comparative Example 1 | 3B |
| Comparative Example 2 | 2B |
| Comparative Example 3 | 3B |

As seen in Table 3, the photosensitive resin compositions of the present invention (Examples 1 to 5) showed very superior adhesivity than Comparative Examples 1 to 3.

3) Testing of Resolution, acid Resistance and Peeling Characteristics

For each 30 μm-thick dry film resist, resolution, acid resistance during etching of the substrate and peeling characteristics against alkali were evaluated. The evaluation result is shown in Table 4 below.

Resolution: Evaluated after immersing in 0.4% Na₂CO₃ solution at 30° C. for 60 seconds.

Acid resistance: Evaluated after immersing in aqua regia at 60° C. for 60 seconds.

Peeling characteristics: Evaluated after immersing in 0.4% KOH solution at 55° C. for 40 seconds.

TABLE 4
Evaluation of resolution, acid resistance
and peeling characteristics

| | | Acid | Peeling |
|---|---|---|---|
| Classification | Resolution | resistance | characteristics |
| Example 1 | 20 m | ◯ | ◯ |
| Example 2 | 20 m | ◯ | ◯ |
| Example 3 | 10 m | ◯ | ◯ |
| Example 4 | 10 m | ◯ | ◯ |
| Example 5 | 20 m | ◯ | ◯ |
| Comparative Example 1 | 50 m | ◯ | ◯ |
| Comparative Example 2 | 80 m | Δ | ◯ |
| Comparative Example 3 | 50 m | ◯ | ◯ |

As seen in Table 4, the photosensitive resin compositions of the present invention (Examples 1 to 5) showed superior developing characteristics and resolution even at low exposure amount and good acid resistance and peeling characteristics compared with the conventional compositions.

1. An acrylate resin represented by the following Chemical Formula 1: 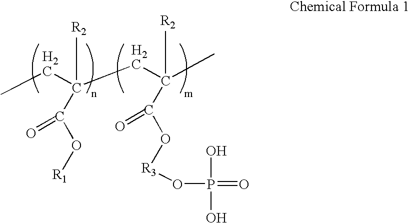
where Ri is hydrogen, C1 to C6 alkyl having or not having an aromatic or hydroxy group; R2 is hydrogen or methyl; R3 is pentaethylene glycol, pentapropylene glycol or hexaethylene glycol; n is an integer of 8 to 40; and m is an integer of 1 to 4.

2. A method of preparing the acrylate resin of claim 1 comprising the step of copolymerizing a) 20 to 50 wt % of unsaturated carbonic acid, b) 15 to 45 wt % of aromatic monomer, c) 1 to 15 wt % of monomer containing phosphate ester and d) 10 to 30 wt % of acryl monomer in a solvent.

3. The method of preparing an acrylate resin according to claim 2 in which said unsaturated carbonic acid is one or more compounds selected from the group consisting of acrylic acid, methacrylic acid, itaconic acid, maleic acid, fumaric acid, vinylacetic acid and acid anhydrides thereof.

4. The method of preparing an acrylate resin according to claim 2 in which said aromatic monomer is one or more compounds selected from the group consisting of styrene, benzyl methacrylate, benzyl acrylate, phenyl acrylate, phenyl methacrylate, 2- or 4-nitrophenyl acrylate, 2-or 4-nitrophenyl methacrylate, 2-or 4-nitrobenzyl methacrylate, 2-or 4-chlorophenyl acrylate and 2-or 4-chlorophenyl methacrylate.

5. The method of preparing an acrylate resin according to claim 2 in which said monomer containing phosphate ester is one or more compounds selected from the group consisting of pentaethylene glycol monomethacrylate, pentapropylene glycol monomethacrylate and hexaethylene glycol monomethacrylate.

6. The method of preparing an acrylate resin according to claim 2 in which said acryl monomer is one or more compounds selected from the group consisting of 2-hydroxyethylethyl (meth) acrylate, 2-hydroxyoctyl (meth) acrylate, methyl (meth) acrylate, ethyl (meth) acrylate and n-butyl acrylate.

7. The method of preparing an acrylate resin according to claim 2 in which said solvent is one or more compounds selected from the group consisting of tetrahydrofuran, dioxane, dimethylaminoformaldehyde, methyl ethyl ketone, carbitol and y-butyrolactone.

8. An alkali-soluble photosensitive resin composition comprising the acrylate resin represented by the following Chemical Formula 1: 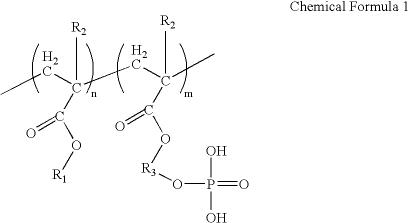
where Ri is hydrogen, Ci to C6 alkyl having or not having an aromatic or hydroxy group; R2 is hydrogen or methyl; R3 is pentaethylene glycol, pentapropylene glycol or hexaethylene glycol; n is an integer of 8 to 40; and m is an integer of 1 to 4.

9. The alkali-soluble photosensitive resin composition of claim 8 comprising: a) the acrylate resin represented by Chemical Formula 1; b) a cross-linking monomer having at least two ethylene double bonds; c) a photo-polymerization initiator; d) a dye and colorant; e) an additive; and f) a solvent.

10. The alkali-soluble photosensitive resin composition of claim 9 comprising: a) 30 to 60 wt % of the acrylate resin represented by Chemical Formula 1; b) 5 to 30 wt % of a cross-linking monomer having at least two ethylene double bonds; c) 0.5 to 10 wt % of a photo-polymerization initiator; d) 0.5 to 3 wt % of a dye and colorant; e) 0.2 to 1 wt % of an additive; and a solvent.

11. The alkali-soluble photosensitive resin composition of claim 8 in which the acrylate resin represented by Chemical Formula 1 has a molecular weight ranging from 20,000 to 100,000.

12. The alkali-soluble photosensitive resin composition of claim 9 in which said cross-linking monomer having at least two ethylene double bonds is one or more compounds selected from the group consisting of 1,4-butanediol diacrylate, 1,3-butylen glycol diacrylate, ethylene glycol diacrylate, pentaerythritol tetraacrylate, triethylene glycol diacrylate, polyethylene glycol diacrylate, dipentaerythritol diacrylate, sorbitol triacrylate, bisphenol A diacrylate derivative, trimethylpropane triacrylate, dipentaerythritol polyacrylate and methacrylates thereof.

13. The alkali-soluble photosensitive resin composition of claim 9 in which said photo-polymerization initiator is one or more compounds selected from the group consisting of 2,4-bistrichloromethyl-6-p-methoxystyryl-s-triazine, 2-p-methoxystyryl-4,6-bistrichloromethyl-s-triazine, 2,4-trichloromethyl-6-triazine, 2,4-trichloromethyl-4-methylnaphtyl-6-triazine, benzophenone, p-(diethylamino)benzophenone, 2,2-dichloro-4-phenoxyacetophenone, 2,2′-diethoxyacetophenone, 2,2′-dibutoxyacetophenone, 2-hydroxy-2-methylpropiophenone, p-t-butyltrichloroacetophenone, 2-methylthioxanthone, 2-isobutylthioxanthone, 2-dodecylthioxanthone, 2,4-dimethylthioxanthone, 2,4-diethylthioxanthone and 2,2′-bis-2-chlorophenyl-4,5,4′,5′-tetraphenyl-2′-1,2′-biimidazole.

14. The alkali-soluble photosensitive resin composition of claim 9 in which said dye and colorant is one or more compounds selected from the group consisting of leuco crystal violet, tribromomethylphenylsulfone, diamond green GH, rhodamine B, auramine base, paramagenta, methyl orange, methylene blue, crystal violet, ethyl violet, phthalocyanine green, basic dye man chic blue 20 and night green B.

15. The alkali-soluble photosensitive resin composition of claim 9 in which said additive is one or more compounds selected from the group consisting of fluorine and silicon based compounds.

16. The alkali-soluble photosensitive resin composition of claim 9 in which said solvent is one or more compounds selected from the group consisting of ethylene glycol monomethyl ether acetate, propylene glycol monomethyl ether, propylene glycol methyl ether acetate, propylene glycol monoethyl ether acetate, diethylene glycol dimethyl ether, diethylene, glycol methyl ethyl ether, cyclohexanone, ethyl-3-methoxypropionate, methyl-3-ethoxypropionate, ethyl-3-ethoxypropionate, methyl ethyl ketone, isopropyl alcohol, ethanol and methanol.

17. A dry film resist obtained by using the alkali-soluble photosensitive resin composition of claim 8.

18. The alkali-soluble photosensitive resin composition of claim 9 in which the acrylate resin represented by Chemical Formula 1 has a molecular weight ranging from 20,000 to 100,000.

19. The alkali-soluble photosensitive resin composition of claim 10 in which the acrylate resin represented by Chemical Formula 1 has a molecular weight ranging from 20,000 to 100,000.
